SEQUENCE LISTING (1 sequence)

SEQ ID NO: 1 - protein, 521 aa, Bacillus amyloliquefaciens
MGLGKKLSVAVAASFMSLTISLPGVQAAENPQLKENLTNFVPKHSLVQSELPSVSDKAIKQYLKQNGKVFKGNPSERLKLIDQTTDDLGYKHFRYVPVVNGVPVKDSQVIIHVDKSNNVYAINGELNNDVSAKTANSKKLSANQALDHAYKAIGKSPEAVSNGTVANKNKAELKAAATKDGKYRLAYDVTIRYIEPEPANWEVTVDAETGKILKKQNKVEHAATTGTGTTLKGKTVSLNISSESGKYVLRDLSKPTGTQIITYDLQNREYNLPGTLVSSTTNQFTTSSQRAAVDAHYNLGKVYDYFYQKFNRNSYDNKGGKIVSSVHYGSRYNNAAWIGDQMIYGDGDGSFFSPLSGSMDVTAHEMTHGVTQETANLNYENQPGALNESFSDVFGYFNDTEDWDIGEDITVSQPALRSLSNPTKYGQPDNFKNYKNLPNTDAGDYGGVHTNSGIPNKAAYNTITKIGVNKAEQIYYRALTVYLTPSSTFKDAKAALIQSARDLYGSQDAASVEAAWNAVGL

(19) United States
(12) Patent Application Publication
(10) Pub. No.: US 2024/0251811 A1
(43) Pub. Date: Aug. 1, 2024

(54) PREPARATION OF PLANT-BASED FERMENTED PRODUCTS EMPLOYING COMBINATION OF MICROORGANISM AND PROTEASE ENZYME, PREFERABLY METALLOPROTEASE

(71) Applicants: DUPONT NUTRITION BIOSCIENCES APS, Copenhagen K (DK); DANISCO US INC, Palo Alto, CA (US)

(72) Inventors: Peter Edvard Degn, Egå (DK); Jacob Franz Ewert, Aarhus (DK); Karina Hansen Kjaer, Brabrand (DK); Collette Lentz, Spring Hill, KS (US); Mindi L. McKibbin, Olathe, KS (US)

(21) Appl. No.: 18/563,637

(22) PCT Filed: May 27, 2022
(86) PCT No.: PCT/US2022/031264

§ 371 Date: Nov. 22, 2023

Related U.S. Application Data
(60) Provisional application No. 63/194,240, filed on May 28, 2021.

(51) Int. Cl. A23C 11/10; A23L 7/104; A23L 11/50; A23L 25/00; A23L 29/00

(52) U.S. Cl. CPC A23C 11/106; A23L 7/104; A23L 11/50; A23L 25/40; A23L 29/06

(57) ABSTRACT

The present invention relates to an enzymatic method of preparing a fermented plant-based product. More specifically, the method involves treating a plant-based liquid substrate having a plant protein content of 1% (w/w) or higher with one or more proteases and a microorganism: and allowing the treated plant-based substrate to ferment to produce the fermented plant-based product. Preferably, the protease is B. amyloliquefaciens neutral metalloprotease (bacillolysin, P7L) and lactic acid bacteria are used for fermentation. At low degree of hydrolysis viscosity of the protease-treated plant protein surprisingly increased, potentially due to the formation of peptides with hydrophobic N-terminal moieties, which could form a gel due to hydrophobic interactions. At higher degree of hydrolysis viscosity was—as expected—reduced.

### CROSS REFERENCE TO RELATED APPLICATIONS

This application claims benefit to U.S. Provisional Application No. 63/194,240, filed May 28, 2021, which is hereby incorporated by reference in its entirety.

### FIELD OF THE INVENTION

The present invention relates to an enzymatic method of preparing a fermented plant-based product. More specifically, the method involves treating a plant-based liquid substrate having a plant protein content of 1% (w/w) or higher with one or more proteases and a microorganism; and allowing the treated plant-based substrate to ferment to produce the fermented plant-based product.

### BACKGROUND OF THE INVENTION

Traditionally, yogurt and related fermented products are all derived from milk, typically bovine milk. While milk is high in protein and other nutrients, many consumers have health concerns about consuming dairy products. For example, dairy products can contribute significant amounts of saturated fat to the diet (depending on consumption levels). Diets high in fat and especially in saturated fat can increase the risk of heart disease and can cause other serious health problems. Other health issues potentially associated with dairy consumption are lactose intolerance and other food allergies.

Non-dairy alternatives are currently available such as soy and almond based yogurts and fermented beverages. But non-dairy yogurts typically have poor texture and bitter flavors compared to their dairy counterparts. There is a continuing need for plant-based, dairy alternatives, having rheological and textural properties more similar to traditional milk-based yogurts and fermented beverages without formation of a bitter taste.

### SUMMARY OF THE INVENTION

In accordance with an aspect of the present invention, a method is presented for preparing a fermented plant-based product, having the steps of (a) treating a plant-based liquid substrate having a plant protein content of 1, 2, 3, 4, 5, 6, 7, 8, 9 or 10% (w/w) or higher with a protease and a microorganism, and (b) allowing the treated substrate to ferment to produce the fermented plant-based product. Optionally, the plant protein content is 6% (w/w) or higher. Optionally, the plant protein is derived from soy, almond, pea, bean, rice or oat.

Optionally, the protease belongs to Enzyme Commission (E.C.) 3.4.24.x (wherein x is any number). Optionally, the protease is from family M4. Optionally, the protease is a metalloprotease or a neutral protease. Optionally, the protease has at least 80, 81, 82, 83, 84, 85, 86, 87, 88, 89, 90, 91, 92, 93, 94, 95, 96, 97, 98, 99 or 100% sequence identity to SEQ ID NO:1. Optionally, the protease has at least 90% sequence identity to SEQ ID NO:1. Optionally, the protease has at least 95% sequence identity to SEQ ID NO:1.

Optionally, the plant-based liquid substrate is treated with the protease before adding said microorganism. Optionally, the protease is added together with the microorganism. Optionally, the protease is added after addition of the microorganism.

Optionally, the microorganism is a lactic acid bacteria. Optionally, the protease is a metalloprotease and the microorganism is a lactic acid bacteria.

Optionally, the microorganism is one or more of Streptococcus, Lactococcus, Lactobacillus, Leuconostoc, Pseudoleuconostoc, Pediococcus, Propionibacterium. Enterococcus, Brevibacterium, or Bifidobacterium or any combination thereof.

Optionally, a fermented plant-based product obtainable by the methods described above is presented.

In still another aspect of the present invention, a fermented plant-based product is presented which has a plant protein content of 1, 2, 3, 4, 5, 6, 7, 8, 9 or 10% (w/w) or higher and which has one or more exogenous proteases and an exogenous microorganism. Optionally, the plant protein content is 6% (w/w) or higher. Optionally, the plant protein is derived from soy, almond, pea, bean, rice or oat.

Optionally, the protease belongs to Enzyme Commission (E.C.) 3.4.24.x (wherein x is any number). Optionally, the protease is from family M4. Optionally, the protease is a metalloprotease or a neutral protease. Optionally, the protease has at least 80, 81, 82, 83, 84, 85, 86, 87, 88, 89, 90, 91, 92, 93, 94, 95, 96, 97, 98, 99 or 100% sequence identity to SEQ ID NO:1. Optionally, the protease has at least 90% sequence identity to SEQ ID NO:1. Optionally, the protease has at least 95% sequence identity to SEQ ID NO:1.

Optionally, the microorganism is a lactic acid bacteria. Optionally, the protease is a metalloprotease and the microorganism is a lactic acid bacteria.

Optionally, the microorganism is one or more of Streptococcus, Lactococcus, Lactobacillus, Leuconostoc, Pseudoleuconostoc. Pediococcus, Propionibacteriun, Enterococcus, Brevibacterium, or Bifidobacterium or any combination thereof.

Optionally, the fermented plant-based product is a high protein yogurt. Greek yogurt, Labneh or sour cream.

In another aspect of the present invention, use of a protease in the production of a fermented high protein plant-based product is presented for:

(a) improving viscosity; (b) improving gel strength: (c) improving texture; (d) improving firmness of curd; (e) providing earlier onset of fermentation; (f) providing earlier onset of gelation; (g) providing earlier conclusion of fermentation; (h) reducing syneresis; (i) improving shelf life, (j) reducing post acidification; (k) improving flavour; (l) reducing stickiness; or (m) any combination of (a) to (l).

In another aspect of the present invention, a method, fermented plant-based product or use as substantially hereinbefore described with reference to any one of the Examples is presented.

In another aspect of the present invention, a method is presented of stabilizing a plant-based milk for use in an acid food matrix comprising treating said plant-based milk with a protease. Optionally, the plant-based milk is soy milk, almond milk, cashew milk, rice milk, coconut milk, macadamia milk or oat milk. Optionally, the acid food matrix is coffee.

Optionally, the protease belongs to Enzyme Commission (E.C.) 3.4.24.x (wherein x is any number). Optionally, the protease is from family M4. Optionally, the protease is a metalloprotease or a neutral protease. Optionally, the protease has at least 80, 81, 82, 83, 84, 85, 86, 87, 88, 89, 90, 91, 92, 93, 94, 95, 96, 97, 98, 99 or 100% sequence identity to SEQ ID NO:1. Optionally, the protease has at least 90% sequence identity to SEQ ID NO:1. Optionally, the protease has at least 95% sequence identity to SEQ ID NO:1.

### BRIEF DESCRIPTION OF THE DRAWINGS

FIG. 1 depicts soy protein (Supro 760 IP) treated with different doses of Enzyme. Before heat treatment (▪) and after a 72° C. heating step (□).

FIG. 2 depicts viscosity measured on soy protein (Supro 760 IP) samples treated with different doses of P7L.

FIG. 3 depicts pea protein (Trupro 2000) treated with different doses of P7L enzyme. Before heat treatment (▪) and after a 72° C. heating step (□)

FIG. 4 shows almond yogurt viscosities measured over shelf life for samples treated with 0-18 ppm P7L enzyme on a protein basis.

FIG. 5 depicts viscosities measured over shelf life for almond yogurt control samples with and without 0.15% total pectin and compared to almond yogurt with 2 ppm P7L on protein basis without pectin addition.

FIG. 6 depicts viscosities measured over shelf life for almond yogurt control samples with and without 0.15% total pectin and compared to almond yogurt with 7 ppm P7L on protein basis without pectin addition.

FIG. 7 shows the pH values measured over shelf life for almond yogurt control samples with and without 0.15% total pectin and compared to almond yogurt with 7 ppm P7 on protein basis without pectin addition.

FIG. 8 depicts viscosities measured over shelf life for coconut and pea yogurt. The control without enzyme addition was compared to yogurt made with 18 ppm P7L on protein basis before pasteurization versus 7, 25, or 50 ppm P7L on protein basis added after pasteurization during the culture addition step.

FIG. 9 depicts viscosities measured for fermented pea protein beverage with 4.15% with and without 192.8 ppm P7L on protein basis versus 6.27% protein with and without 223.4 ppm P7L.

FIG. 10 depicts viscosities measured for fermented soy protein beverages with 15, 20, or 25 grams of protein per serving without enzyme addition versus beverages with 15.6, 31.1, or 62.2 ppm P7L on protein basis.

FIG. 11 shows espresso (pH=5) mixed with different oat-based beverages. The oat-based beverages were either not treated with P7L (control) or with P7L in range of 0.1-1 ppm during production. The picture was taken 6 min after mixing the oat-drinks and the coffee.

FIG. 12 shows steam frothed oat drink treated with 0.1 ppm P7L directly after purring into an espresso with a pH of 5.

### BRIEF DESCRIPTION OF THE SEQUENCE ID NOS

SEQ ID NO:1 is the full amino acid sequence of the P7L from Bacillus amyloliquefaciens.

### DETAILED DESCRIPTION

The present disclosure provides methods, apparatuses, compositions and kits that improve properties of plant-based products. In some embodiments, the present disclosure provides methods, apparatuses, compositions and kits that improve properties of plant-based products by using one or more enzymes. In some embodiments, the present disclosure provides methods, apparatuses, compositions and kits that improve rheological properties and the overall acceptability of fermented plant-based products, e.g., viscosity of plant-based yogurt products.

Unless defined otherwise, all technical and scientific terms used herein have the same meaning as commonly understood by one of ordinary skill in the art to which this disclosure belongs. Singleton, et al., DICTIONARY OF MICROBIOLOGY AND MOLECULAR BIOLOGY. 20 ED., John Wiley and Sons, New York (1994), and Hale & Marham, THE HARPER COLLINS DICTIONARY OF BIOLOGY. Harper Perennial. NY (1991) provide one of skill with a general dictionary of many of the terms used in this disclosure.

This disclosure is not limited by the exemplary methods and materials disclosed herein, and any methods and materials similar or equivalent to those described herein can be used in the practice or testing of embodiments of this disclosure. Numeric ranges are inclusive of the numbers defining the range. Unless otherwise indicated, any nucleic acid sequences are written left to right in 5′ to 3′ orientation; amino acid sequences are written left to right in amino to carboxy orientation, respectively. The headings provided herein are not limitations of the various aspects or embodiments of this disclosure which can be had by reference to the specification as a whole. Accordingly, the terms defined immediately below are more fully defined by reference to the specification as a whole.

It must be noted that as used herein and in the appended claims, the singular forms “a”, “an”, and “the” include plural referents unless the context clearly dictates otherwise. Thus, for example, reference to “a protease” includes a plurality of such enzymes and reference to “the feed” includes reference to one or more feeds and equivalents thereof known to those skilled in the art, and so forth.

The publications discussed herein are provided solely for their disclosure prior to the filing date of the present application. Nothing herein is to be construed as an admission that such publications constitute prior art to the claims appended hereto.

### Plant-Based Products

In some embodiments the present invention provides methods, apparatuses, compositions and kits that improve properties of fermented plant-based products.

A “fermented plant-based product” is a product, preferably an edible product, which may also be referred to as a “food product” or “feed product”. The fermented plant-based product is a product produced by fermentation with a microorganism (as defined below).

In some embodiments, the fermented plant-based product is a dairy analogue product, preferably a plant-based yogurt, a plant-based Greek yogurt, a Labneh, a plant-based frozen yogurt, plant-based fresh cheese, plant-based quark or skyr analog, plant-based lebhen analog, plant-based rjaschenka analog, plant-based a cheese analogue (such as an acid curd cheese, a hard cheese, a semi-hard cheese, a cottage cheese), a plant-based butter, a butter plant-based, quark, a plant-based sour cream, kefir, a fermented plant whey-based beverage, a plant-based beverage, a plant-based fermented drink, a matured plant-based cream, a fromage frais, a plant-based curd, a processed cheese analogue, a plant-based cottage cheese, a plant-based cream dessert.

In some embodiments the fermented plant-based product is a plant-based yogurt, preferably a set yogurt or a stirred yogurt.

A stirred plant-based yogurt has been stirred after fermentation for at least 5 to 60 seconds. Most preferably, a stirred yogurt has been stirred after fermentation for at least 10 seconds. Most preferably, a stirred yogurt has been stirred after fermentation for at least 20 seconds. In a preferred embodiment, a stirred yogurt has been stirred after fermentation for at least 30 seconds. Stirring can be carried out with a hand mixer or electric mixer. A set yogurt is not stirred after fermentation. After fermentation a set yogurt may be cooled and then stored. This is carried out without stirring.

The phrase “after fermentation” as used above means when fermentation is ended. Fermentation preferably ends when a specific pH of the fermenting culture is reached. This pH is preferably between 3 and 6, most preferably between 4 and 5. In one embodiment the pH at which fermentation ends is 4.1. In a further embodiment the pH at which fermentation ends is 4.2. In another embodiment the pH at which fermentation ends is 4.3. In another embodiment the pH at which fermentation ends is 4.4. In another embodiment the pH at which fermentation ends is 4.5. In another embodiment the pH at which fermentation ends is 4.6. In another embodiment the pH at which fermentation ends is 4.7. In another embodiment the pH at which fermentation ends is 4.8. In a further embodiment the pH at which fermentation ends is 4.9. In some embodiments, fermentation ends at a pH which inactivates, or reduces the activity of a low pH sensitive peptidase used as described below. This is pH 4.6-4.8.

As used herein, the term “yoghurt” is an alternative spelling of “yogurt” with an identical meaning.

In a preferred embodiment, the fermented plant-based product is stirred during or following the fermentation step. Preferably stirring is carried out for at least 5 to 60 seconds, or more than 60 seconds. In one embodiment stirring is carried out for, at least 10 to 30 seconds. In a further embodiment stirring is carried out for at least 12 to 20 seconds. In a preferred embodiment stirring is carried out for at least 15 seconds. Stirring can be carried out with a hand mixer or electric mixer.

In one embodiment, the fermented plant-based product is cooled, preferably immediately. This cooling may take place for example, using a water bath or heat exchanger. Preferably the fermented plant-based product is cooled to 20-30° C. Most preferably the fermented plant-based product is cooled to around 25° C. or to 25° C.

Alternatively, in one embodiment the fermented plant-based product is cooled to a lower temperature of 1-10° C., most preferably 4-6° C. In one embodiment this cooling is carried out slowly by placing the fermented plant-based product in a cold room or refrigerator.

In a preferred embodiment the fermented plant-based product is cooled immediately to 20-30° C., most preferably to around 25° C. or to 25° C. Then the fermented plant-based product is cooled for a second time, but this time to 1-10° C., most preferably 4-6° C. In one embodiment the fermented plant-based product is cooled for a second time to 3° C. In another embodiment the fermented plant-based product is cooled for a second time to 4° C. In a further embodiment the fermented plant-based product is cooled for a second time to 5° C. In some embodiments the second cooling is carried out slowly, for example over 10 to 48 hours. In one embodiment, cooling is carried out over 12 to 20 hours. In a preferred embodiment cooling is carried out over 15 to 20 hours. In a most preferred embodiment cooling is carried out over 10 hours or cooling is carried out over 15 hours. Most preferably this second cooling is carried out in a cold room or refrigerator.

In some embodiments, the stirring described above is carried out immediately after fermentation and before any cooling step. Stirring may also be carried out between two cooling steps.

In some embodiment the fermented product is concentrated via UF-filtration or a decanter after fermentation.

In some embodiment the fermented product is heated-treated after the production to temperatures >50C.

The method of the invention may further include a storage step after fermentation. This may be carried out after stirring and/or cooling (one or more times), preferably after both.

The fermented plant-based product produced by the methods of the current invention has one or more of the following features: (a) improved viscosity; (b) improved gel strength; (c) improved texture; (d) improved firmness of curd; (e) earlier onset of fermentation; (f) earlier onset of gelation; (g) earlier conclusion of fermentation; (h) reduced syneresis; (i) improved shelf-life; (j) reduced post acidification (k) improved flavor (e.g. less off-flavor); (l) decreased stickiness; (m) improved hardness, (n) improved cohesiveness, (o) improved adhesiveness; or (p) any combination of (a) to (o).

In one embodiment, the fermented plant-based product produced by the methods of the current invention has improved viscosity.

In one embodiment, the fermented plant-based product produced by the methods of the current invention has improved gel strength.

In one embodiment, the fermented plant-based product produced by the methods of the current invention has improved texture.

In a further embodiment, the fermented plant-based product produced by the methods of the current invention has improved firmness of curd.

In one embodiment, the fermented plant-based product produced by the methods of the current invention has earlier onset of fermentation.

In a further embodiment, the fermented plant-based product produced by the methods of the current invention has earlier onset of gelation.

In a preferred embodiment, the fermented plant-based product produced by the methods of the current invention has earlier conclusion of fermentation.

In one embodiment, the fermented plant-based product produced by the methods of the current invention has reduced syneresis.

In a preferred embodiment, the fermented plant-based product produced by the methods of the current invention has improved shelf-life. In a preferred embodiment, the fermented plant-based product produced by the methods of the current invention has improved flavor.

In a preferred embodiment, the fermented plant-based product produced by the methods of the current invention has decreased stickiness.

These features change the texture of the fermented plant-based product, preferably a yogurt, and also change the mouthfeel and taste. In some embodiments, the fermented plant-based product produced by the methods of the current invention has improved taste, e.g., less off-flavor and/or less bitterness.

The fermented plant-based product of the current invention also has a longer shelf life than a fermented plant-based product, most preferably a yogurt, which is not produced by the method of the invention and/or not produced using the one or more enzymes described herein.

As used herein, a “longer shelf-life” means that the fermented plant-based product can be stored for longer without a change in the texture, mouthfeel or taste, or an increase in syneresis of the product.

Storage is preferably carried out at a low temperature, preferably less than 10° C., most preferably 0-10° C. and more preferably 4-6° C.

In some embodiments, the shelf-life is of the fermented plant-based product, most preferably a yogurt, produced by the method of the invention is increased by 5 to 75 days compared to a fermented plant-based product which is not produced by the method of the invention and/or not produced using the one or more enzymes described herein.

In some embodiments, the shelf-life is of the fermented plant-based product, produced by the method of the invention is increased by 5 to 75 days compared to a fermented plant-based product which is not produced by the method of the invention and/or not produced using the enzymes described herein.

When two fermented plant-based products are compared, such as a product produced by the methods of the invention compared to one produced by other methods, they should be the same type of fermented plant-based product, for example a yogurt. This is illustrated in the examples.

As used herein, the term “plant-based substrate” may encompass any plant-based or plant-based product. In particular the plant-based substrate may be from soy plant, oat, pea, almond, coconut, rice, canola, lentils, hemp, chia, lupin, sunflower, rapeseed, rye, maize, sorghum, potato, millet, wheat, barley, groundnut. The plant-based substrate may also be a blended plant-based. A plant-based substrate is the starting material to which the method of the invention as described herein is applied. An “inoculated plant-based substrate” as used herein means a plant-based substrate with lactic acid bacteria (LAB) added to it.

As used herein the term “plant milk” or “plant-milk” means a manufactured, non-dairy product comprising water and one or more plant proteins. For example, if the plant proteins are derived from almonds, the product could be referred to as almond milk or almond-milk. Similarly, depending on the source of plant proteins, the present invention contemplates soy milk, rice milk, cashew milk, oat milk, etc.

The plant-based substrate used in the method of the invention has a protein content of 1% (w/w) or higher. For example, the plant-based substrate may have a protein content of 2%, 3%, 4.5%, 5%, 5.5%, 6%, 6.5%, 7%, 7.5%, 8%, 8.5%, 9%, 9.5% or 10% (w/w) or more. Protein content is typically measured in terms of protein weight to volume (w/v) or protein weight to total weight (w/w). Where it is not specified herein, it may be assumed that the measurement of protein content is in terms of protein weight to total weight (w/w). Plant-based substrates or fermented plant-based products that have a protein content of 6% (w/w) or greater are referred to herein as “high protein”.

The plant-based substrate may be standardized based on its protein content based on their dry matter content, via FTIR-methods, Kjeldahl or chromogenic protein determination methods like Bradford or BCA.

The plant-based substrate is preferably pasteurized and/or pre-pasteurized before or after treatment with the enzymes described herein. Pasteurization involves heating the plant-based substrate to at least 72° C. for at least 15 seconds, preferably 25 seconds or more. In one embodiment pasteurization is carried out at least 73° C. for at least 15 seconds. In one embodiment pasteurization is carried out at least 75° C. for at least 15 seconds. In a further embodiment pasteurization is carried out at least 85° C. for at least 15 seconds. In a further embodiment pasteurization is carried out at least 90° C. for at least 15 seconds. In another embodiment pasteurization is carried out at least 95° C. for at least 15 seconds.

Pasteurization may be carried out for at least 30 seconds. In some embodiments, pasteurization may be carried out for at least 1 minute. In further embodiments, pasteurization may be carried out for at least 2-15 minutes. In another embodiment, pasteurization may be carried out for at least 3-10 minutes. In a further embodiment, pasteurization may be carried out for at least 15 minutes or more. Pasteurization may take place in an autoclave.

In some embodiments, pasteurization is carried out at least 95° C. for 4-6 minutes. In some embodiments, pasteurization is carried out at least 85° C. for 30 minutes.

In some embodiments, both pre-pasteurization and pasteurization are carried out. In some embodiments, pre-pasteurization is carried out on the raw plant-based before standardization. In some embodiments, pre-pasteurization is carried out at 72-85° C., such as 72-75° C. or 72° C. In one embodiment pre-pasteurization is carried out for 15-25 seconds, most preferably 15 seconds. In one aspect of the invention, the plant-based substrate is pasteurized after standardization.

Preferably this is carried out at the temperatures and for the times described above. In some embodiments, pasteurization after standardization is carried out at around 90° C. for around 10 minutes, preferably at 90° C. for 10 minutes. Pasteurization as described above may also be carried out in the absence of standardization.

In one aspect the plant-based substrate has a pH (before fermentation) of 6-8, most preferably of at or around pH 6-7 and in some embodiments of at or around pH6.7-6.8.

The plant-based substrate is treated with one or more of the enzymes described herein. As used herein, the terms “treating” and “treated” may encompass, adding to, mixing with, incubating with, stirring with, contacting with, fermenting with, inoculating with, admixing and applying to. In some embodiments, the plant-based substrate is treated with the one or more enzymes described herein before or after pasteurization. In some embodiments, the plant-based substrate is treated with the one or more enzymes as described herein before pasteurization, and with additional one or more enzymes as described herein after pasteurization. The one or more enzymes for the treatment before pasteurization can be the same as the one or more enzymes for treatment after pasteurization, or they can be different.

In some embodiments, the one or more enzymes for the treatment before pasteurization are different than the one or more enzymes for treatment after pasteurization.

The term “treating” is used herein to mean the addition of one or more proteases and a microorganism to the plant-based substrate.

### Fermentation

As used herein, the term “fermentation” refers to the conversion of carbohydrates (such as sugars) to alcohols and CO₂ or organic acids using microorganisms such as yeasts and bacteria or any combination thereof. Fermentation is usually carried out under anaerobic conditions. A fermented product has been produced using fermentation.

As used herein, the term “allowing the treated plant-based substrate to ferment” means fermenting the plant-based substrate. This may include incubating the treated plant-based substrate under suitable conditions (e.g. anaerobic) and at a suitable temperature for a sufficient period of time for fermentation to occur.

In the case of the fermented plant-based products of the invention, preferably they result from a plant-based substrate inoculated with a lactic acid bacterium, or any microbes that have GRAS status and can acidify plant-based by fermenting plant-based carbohydrates. For example a thermophilic culture such as YO-Mix 465, 532, 860, 414, 883, 885, Ml 1, 863, 410, 450, 495, 496, 499, 810, 860, 854, 863, 896, T42, Danisco® VEGE 033, Danisco® VEGE 038, Danisco® VEGE 053, Danisco® VEGE 022, Danisco® VEGE 061, Danisco® VEGE 011, Danisco® VEGE 092, Danisco® VEGE 081, Danisco® VEGE C-102 or Danisco® HOLDBAC YM VEGE+Danisco® HOLDBAC LC or a mesophilic culture such as Choozit 220, Choozit 230 or Probat 505. These culture strains are commercially available from DuPont.

In one embodiment, the plant-based substrate is fermented at 35-55° C., preferably 40-50° C. This temperature range is preferable for a thermophilic microorganism or a thermophilic culture. Most preferably, the fermentation temperature for a thermophilic microorganism or a thermophilic culture is 41° C. In some embodiments, the fermentation temperature is 42° C. In some embodiments, the fermentation temperature is 43° C. In other embodiments, the fermentation temperature is 44° C. In some embodiments, the fermentation temperature is 45° C. In another embodiment, the plant-based substrate is fermented at 15-30° C., preferably 20-25° C. This temperature range is preferable for a mesophilic microorganism or a mesophilic culture. Most preferably, the fermentation temperature for a mesophilic microorganism or a mesophilic culture is 21° C. In some embodiments, the fermentation temperature is 22° C. In some embodiments the fermentation temperature is 23° C. In other embodiments, the fermentation temperature is 24° C. In some embodiments, the fermentation temperature is 25° C. Examples for fermentation temperature include at 30, 37 and 43° C. Fermentation temperature may affect the properties of the resulting fermented plant-based product.

In some embodiments, fermentation is conducted in a water bath or heat exchanger. In some embodiments, fermentation is carried in a fermentation tank or a beaker. In particular fermentation is carried in a fermentation tank for stirred yogurt or in a beaker for set yogurt. In some embodiments, fermentation, is ended when a specific pH is reached. This pH is preferably a more acidic pH than the starting pH of the plant-based substrate, most preferably a pH between 3 and 6, more preferably between 4 and 5. In some embodiments the pH at which fermentation ends is 4.5-4.8. In some embodiment the pH at which fermentation ends is 4.7. In some embodiments, the pH at which fermentation ends is 4.7. In some embodiments, the pH at which fermentation ends is at or around 4.6.

Most preferably, fermentation ends when the reduction in pH reduces the activity of, or completely inactivates, the low pH sensitive peptidase.

In some embodiments, after fermentation, the now fermented plant-based product is cooled, preferably immediately as described above (see section entitled “Fermented Plant-based Product”).

This may be before or after stirring, or no stirring may occur depending on the preferred product. This cooling may take place for example, using a water bath. Cooling can take place in one or two steps as described above. In some embodiments, the fermented plant-based product is cooled to 20-30° C. In some embodiments, the fermented plant-based product is cooled to around 25° C. or to 25° C. Alternatively, in one embodiment the fermented plant-based product is cooled to a lower temperature of 1-10° C., most preferably 4-6° C., after step (b) of the method of the invention. In some embodiments, this cooling is carried out slowly by placing the fermented plant-based product in a cold room or refrigerator. Alternatively, both of these cooling steps can be applied, one after the other (as described above).

Fermentation may be stopped by cooling, or by the pH which may inhibit or kill the microorganisms of the fermentation culture. Cooling stops the fermentation process. The fermented plant-based product can be stored at preferably 4-6° C., as further described above.

### Microorganism

The methods as described herein use a microorganism. This is for fermentation purposes. The microorganism used according to the invention is an exogenous microorganism. The term “exogenous” as used herein means that the microorganism is not typically found in plant-based, and hence is obtained from a different (i.e. non-plant-based) source.

In some embodiments, said microorganism is a lactic acid bacterium.

As used herein, the term “lactic acid bacteria” (LAB) refers to any bacteria which produce lactic acid as the end product of carbohydrate fermentation. In a particular embodiment, the LAB is selected from the group consisting of species Streptococcus, Lactococcus, Lactobacillus, Leuconostoc, Pseudoleuconostoc, Pediococcus, Propionibacterium, Enterococcus, Brevibacterium and Bifidobacterium or any combination thereof. Examples of suitable microorganism strains include Lactococcus lactis subsp lactis, Lactococcus lactis subsp cremoris, Lactococcus lactis subsp. lactis biovar diacetylactis, Leuconostoc mesenteroides subsp cremoris, Lactococcus lactis subsp lactis, Lactococcus lactis subsp cremoris. Streptococcus thermophilus and Lactobacillus delbrueckii subsp. Bulgaricus. A fermenting or otherwise growing colony of microorganisms (particularly LAB) may be referred to as a “culture”.

In a further aspect, the LAB is a thermophilic culture. In some embodiments, fermentation of such a LAB is carried out at 30-55° C., most preferably 37-43° C. and most preferably at 43° C.

In particular, the lactic acid bacteria (LAB) may be used in a blended culture, in an inoculum or a starter culture.

### Starter Culture

The lactic acid bacteria (LAB) may be used in a starter culture.

In a particular embodiment the starter culture of the invention comprises the LAB and a low pH sensitive peptidase as described above.

The starter culture of the invention may be frozen, dried (e.g. spray dried), freeze dried, liquid, solid, in the form of pellets or frozen pellets, or in a powder or dried powder. The starter culture may be formulated and/or packaged as described above.

The starter culture may also comprise more than one LAB strain. In some embodiments, said LAB starter culture, has a concentration of LAB which is between 107 and 1011 CFU, and more preferably at least at least 107, at least 108, at least 109, at least 1010 or at least 1011 CFU/g of the starter culture.

The invention also provides the use of a starter culture as defined above. The starter culture of the invention may preferably be used for producing a fermented plant-based product, in particular a fermented plant-based product of the invention. A fermented plant-based product of the invention may be obtained and is obtainable by adding a starter culture to a plant-based substrate and allowing the treated plant-based substrate to ferment.

### Proteolytic Enzymes

In one aspect, the present invention is directed to systems, compositions and methods for improving the properties of plant-based products comprising adding one or more enzymes during the process. In one embodiment, the present invention provides compositions and methods for improving the properties of plant-based products comprising adding one or more proteases alone or in combination with other enzymes during the process.

The protease used according to the invention is an exogenous protease. The term “exogenous” as used herein means that the protease is not typically found in plants, and hence is obtained from a different (i.e. non-plant) source.

The term “protease” as used herein is synonymous with peptidase or proteinase. The protease for use in the present invention may be a metalloprotease, or a neutral protease. Suitable proteases include microbial origin. Chemically modified or protein engineered mutants are also suitable. The protease may be a metalloprotease, microbial protease

In one embodiment the protease for use in the present invention may be one or more of the proteases in Neutrase 0.8L™ Novozymes protease B. amyloliquefaciens. Suitably, the protease may be a protease from Bacillus (such as Bacillus subtilis, Bacillus anvloliquefaciens, B. alcalophilus and B. licheniformis).

In one embodiment, the protease is from Bacillus. Suitably, the protease may be from the species Bacillus subtilis, Bacillus annioliquefaciens, B. alcalophilus, B. lentus and B. licheniformis. In one embodiment, the protease is from the species Bacillus amyloliquefaciens.

In one embodiment, the protease has the amino acid SEQ ID NO:1. In some embodiments, the protease has at least 80, 81, 82, 83, 84, 85, 86, 87, 88, 89, 90, 91, 92, 93, 94, 95, 96, 97, 98 or 99% identity with the amino acid SEQ ID No.1.

In some embodiments, the protease for use in the present invention may be a low pH sensitive peptidase.

In some embodiments, the protease for use in the present invention may be a metalloprotease.

The term “metalloprotease” as used herein refers to an enzyme having protease activity, wherein the catalytic mechanism of the enzyme involves a metal, typically having a metal ion in the active site.

In some embodiments, the metalloprotease is a low pH sensitive peptidase. The metal ion or ions of a metalloprotease may be any metal ion. Most preferably the metalloprotease as used herein contains metal ion or ions which are zinc, calcium or a combination of zinc and calcium.

Treatment with chelating agents removes the metal ion and inactivates metalloproteases. For example, EDTA is a metal chelator that removes essential zinc from a metalloprotease and therefore inactivates the enzyme.

In some embodiments, the metalloprotease as used herein has a divalent ion, or two divalent ions, or more than two divalent ions at the active site.

In some embodiments, the metalloprotease as used herein has a calcium or zinc ion in the active site, most preferably Zn2+. In some preferable metalloproteases there may be one zinc ion, in others there may be two or more zinc ions.

Preferably a metalloprotease comprises a His-Glu-Xaa-Xaa-His motif (where “Xaa” is any amino acid) which forms the metal ion binding site or part thereof.

In one embodiment, wherein the metalloprotease is a member of the GluZincin superfamily, a zinc ion is bound by the amino acid motif His-Glu-Xaa-Xaa-His plus an additional glutamate. Preferably it contains 1 zinc ion and 2 calcium ions.

In some embodiments, the metalloprotease is from family M4, or the GluZincin superfamily. The M4 enzyme family is characterized in that all enzymes in this family bind a single, catalytic zinc ion. As in many other families of metalloproteases, there is an His-Glu-Xaa-Xaa-His motif. The M4 family is further defined in Biochem.J. 290:205-218 (1993).

In some embodiments, the metalloprotease used in the present invention adopts a 3D structure similar to protein databank structures 1 BQB (Staphylococcus aureus metalloprotease), 1 EZM (Pseudomonas aeruginosa metalloprotease) and 1 NPC (Bacillus cereusmetalloprotease). In a preferred embodiment, the metalloprotease has a cannibalistic autolysis site. This means that the metalloprotease may cause lysis of itself.

As used herein, the term “metalloprotease” may be used interchangeably with “metallopeptidase”, “metalloproteinase” and “neutralaprotease”. In some embodiments, the metalloprotease or a protease as described herein is low pH sensitive. As used herein, the term “low pH sensitive” refers to a peptidase whose pH optimum is the same as or close to the pH of the plant base (pH6.5-6.7) and whose activity is at least 2 times lower at pH 4.6-4.8 compared to pH6.5-6.7.

In some embodiments, the low pH sensitive peptidase used in the present invention has an activity at least 10 times lower at pH 4.6-4.8 compared to pH6.5-6.7, and most preferably at least 15 times lower.

In some embodiments, during fermentation the production of organic acids (e.g. lactic acid) lowers the pH and deactivates the low pH sensitive peptidases during the methods of the invention.

In some embodiments, the low pH sensitive peptidase is irreversibly inactivated by low pH of 4.6-4.8. In a preferred embodiment, the low pH that reduces or inactivates the peptidases used in the invention is caused by fermentation. Most preferably this low pH is caused by microbial fermentation of sugars to organic acids, such as the fermentation of lactose to lactic acid. Most preferably the inactivation is permanent and the resulting fermented plant-based product therefore contains little, no, or only trace amounts of active peptidase. Preferably proteolytic activity is reduced, most preferably stopped, by the end fermentation, or before or during storage.

The reduction in activity at low pH for low pH sensitive peptidases that are metalloproteases is preferably caused by the disassociation of the metal ions. These metal ions are essential to the function of the enzyme, as described above.

The term “reduced activity” as used herein in the context of peptidases means a reduction in protease activity (also known as “peptidase activity”, “enzyme activity”, “endopeptidase activity” or “exopeptidase activity”) of 2 times or more units of peptidase activity compared to the units of peptidase activity at the activity maximum of pH6.5-6.7. In a preferred embodiment, “reduced activity” refers to activity of less than 50% that at the activity maximum of pH 6.5-6.7.

The term “inactivates” as used herein in the context of peptidases means a reduction in protease activity of 2 times or more units of peptidase activity compared to the units of peptidase activity at the activity maximum of pH 6.5-6.7. In a preferred embodiment, “inactivated” refers to activity of less than 90% that at the activity maximum of pH 6.5-6.7.

In one embodiment the low pH sensitive peptidase is a thermostable peptidase. As used herein, the term “themostable” means the enzyme has protease activity at temperatures of greater than 30° C., preferably 30° C.-60° C.

In one embodiment of the present invention, the low pH sensitive peptidase belongs to Enzyme Commission (E.C.) No. 3.4.24.x (wherein x is any number).

In a further embodiment, the low pH sensitive peptidase is a thermolysin, an NprE molecule, proteolysin, aureolysin, Gentlyase or Dispase, or a peptidase having a high percentage identity to such an enzyme.

In some embodiments, the low pH sensitive peptidase used in the present invention is not chymosin or chymosin-like (that is, does not have chymosin-like activity and does not specifically cleave the Met105-Phe106 bond), and does not belong to E.C. No. 3.4.23.4. The low pH sensitive peptidase used in the present invention preferably does not cleave the Met105-Phe106 bond, and most preferably does not cleave strictly the Met105-Phe106 bond only.

In some embodiments, the peptidase used consists of or comprises a mature protein excluding any signal sequence. In a further embodiment, the peptidase consists of or comprises a full length protein including a signal sequence.

In some embodiments, the low pH sensitive peptidase is of non-mammalian origin, and most preferably of non-animal origin. In some embodiments, the low pH sensitive peptidase is a bacterial peptidase, a fungal peptidase, an archaeal peptidase or an artificial peptidase. In some embodiments the low pH sensitive peptidase is a bacterial metalloprotease, a fungal metalloprotease, an archaeal metalloprotease or an artificial metalloprotease.

An artificial peptidase is an enzyme in which one or more amino acids have been mutated, substituted, deleted or otherwise altered so the amino acid sequence of the enzyme differs from the wild-type, wherein the wild-type is obtainable from a living organism. An artificial peptidase may also be referred to as a variant peptidase.

Peptidases of bacterial origin as used herein are preferably obtained or obtainable from Bacillus species, most preferably Bacillus amyloliquefaciens or Bacillus pumilus. Most preferably the low pH sensitive peptidase is, or has a high percentage identity to, Protex 7L (P7L) which is available from DuPont, also known as, NprE, P7L, FoodPro PNL, Zymstar T, Bacillolysin, Stearolysin, thennolysin-like enzyme, thennolysin-like protease, thermoase, ProtexI4L or Neutrase. Such a peptidase is shown as SEQ ID NO: 1 and encoded by the nucleotide sequence of SEQ ID NO:2. P7 is a metalloprotease.

In one embodiment the low pH sensitive peptidase as used herein comprises a polypeptide having the amino acid sequence of SEQ ID NO:1 or a polypeptide having at least 70%, such as at least 75%, such as at least 80%, such as at least 85%, such as at least 90%, such as at least 95%, such as at least 97%, such as at least 98%, such as at least 99%, sequence identity thereto, or a functional variant thereof.

In one embodiment the low pH sensitive peptidase as used herein comprises a polypeptide having the amino acid sequence of SEQ ID NO:1, or a polypeptide having at least 70%, 75%, 80%, 85%, 90%, 95%, 97%, 98%, 99% sequence identity thereto, or a functional variant thereof.

In one embodiment the low pH sensitive peptidase as used herein comprises a polypeptide having the amino acid sequence of SEQ ID NO:1, or a polypeptide having one or several amino acid deletions, substitutions and/or additions, or a functional variant thereof. For example, such a polypeptide may have 1, 2, 3, 4, 5, 6, 7, 8, 9, 10, 15, 20 or more amino acid deletions, substitutions and/or additions.

As used herein, a “functional variant” of a peptidase meant that the enzyme has peptidase activity despite changes such as substitutions, deletions, mutations, missing or additional domains and other modifications.

As used herein, a “functional variant” of a metalloprotease meant that the enzyme has metalloprotease activity despite changes such as substitutions, deletions, mutations, missing or additional domains and other modifications.

In one embodiment the low pH sensitive peptidase comprises a full length enzyme including a signal peptide (also known as a signal sequence). A signal sequences directs the secretion of the polypeptide through a particular prokaryotic or eukaryotic cell membrane. In one embodiment the low pH sensitive peptidase comprises a polypeptide having the amino acid sequence of SEQ ID NO:1, lacking a signal sequence.

In a further embodiment the low pH sensitive peptidase comprises an amino acid sequence having at least 70%, such as at least 75%, such as at least 80%, such as at least 85%, such as at least 90%, such as at least 95%, such as at least 97%, such as at least 98%, such as at least 99%, sequence identity to SEQ ID NOs: 1 lacking a signal peptide, or a functional variant thereof. In a further embodiment the low pH sensitive peptidase comprises an amino acid sequence having at least 70%, 75%, 80%, 85%, 90%, 95%, 97%, 98% or 99% sequence identity to SEQ ID NOs:1 and also lacking a signal peptide, or a functional variant thereof.

Peptidases, like all proteins, may be encoded by a nucleic acid having a nucleotide sequence. The low pH sensitive peptidases used in the current invention may be obtained from or obtainable from a nucleic acid, for example as demonstrated by SEQ ID NO: 2 or a variation thereof, which encodes SEQ ID NO:1, Said nucleic acid may be expressed in a host cell. Said nucleic acid may be obtained or obtainable from a host cell.

In some embodiments, the enzyme has a total number of amino acids of less than 350, such as less than 340, such as less than 330, such as less than 320, such as less than 310, such as less than 300 amino acids, such as in the range of 200 to 350, such as in the range of 220 to 345 amino acids than the one or more enzyme described herein.

In some embodiments, the amino acid sequence of the enzyme has at least one, two, three, four, five, six, seven, eight, nine or ten amino acid substitutions.

The amino acid sequence may be prepared/isolated from a suitable source, or it may be made synthetically, or it may be prepared by use of recombinant DNA techniques.

The protein encompassed in the present invention may be used in conjunction with other proteins, particularly enzymes. Thus, the present invention also covers a combination of proteins wherein the combination comprises the protease of the present invention and another enzyme, which may be another protease according to the present invention.

Preferably the amino acid sequence when relating to and when encompassed by the per se scope of the present invention is not a native enzyme. In this regard, the term “native enzyme” means an entire enzyme that is in its native environment and when it has been expressed by its native nucleotide sequence.

### PREFERRED EMBODIMENTS OF THE INVENTION

In accordance with an aspect of the present invention, a method is presented for preparing a fermented plant-based product, having the steps of (a) treating a plant-based liquid substrate having a plant protein content of 1, 2, 3, 4, 5, 6, 7, 8, 9 or 10% (w/w) or higher with a protease and a microorganism, and (b) allowing the treated substrate to ferment to produce the fermented plant-based product. Preferably, the plant protein content is 6% (w/w) or higher. Preferably, the plant protein is derived from soy, almond, pea, bean, rice or oat.

Preferably, the protease belongs to Enzyme Commission (E.C.) 3.4.24.x (wherein x is any number). More preferably, the protease is from family M4. Still more preferably, the protease is a metalloprotease or a neutral protease. Yet more preferably, the protease has at least 80, 81, 82, 83, 84, 85, 86, 87, 88, 89, 90, 91, 92, 93, 94, 95, 96, 97, 98, 99 or 100% sequence identity to SEQ ID NO:1. In yet more preferred embodiments, the protease has at least 90% sequence identity to SEQ ID NO:1. Most preferably, the protease has at least 95% sequence identity to SEQ ID NO:1.

Preferably, the plant-based liquid substrate is treated with the protease before adding said microorganism. In other preferred embodiments, the protease is added together with the microorganism. In still other preferred embodiments, the protease is added after addition of the microorganism.

Preferably, the microorganism is a lactic acid bacteria. More preferably, the protease is a metalloprotease and the microorganism is a lactic acid bacteria.

In other preferred embodiments, the microorganism is one or more of Streptococcus, Lactococcus. Lactobacillus. Leuconostoc, Pseudoleuconostoc. Pediococcus, Propionibacterium, Enterococcus, Brevibacterium, or Bifidobacteriun or any combination thereof.

In another aspect of the present invention, a fermented plant-based product obtainable by the methods described above is presented.

In still another aspect of the present invention, a fermented plant-based product is presented which has a plant protein content of 1, 2, 3, 4, 5, 6, 7, 8, 9 or 10% (w/w) or higher and which has one or more exogenous proteases and an exogenous microorganism. Preferably, the plant protein content is 6% (w/w) or higher. Preferably, the plant protein is derived from soy, almond, pea, bean, rice or oat.

Preferably, the protease belongs to Enzyme Commission (E.C.) 3.4.24.x (wherein x is any number). More preferably, the protease is from family M4. Still more preferably, the protease is a metalloprotease or a neutral protease. Yet more preferably, the protease has at least 80, 81, 82, 83, 84, 85, 86, 87, 88, 89, 90.91, 92, 93, 94, 95, 96, 97, 98, 99 or 100% sequence identity to SEQ ID NO:1. In yet more preferred embodiments, the protease has at least 90% sequence identity to SEQ ID NO:1. Most preferably, the protease has at least 95% sequence identity to SEQ ID NO:1.

Preferably, the microorganism is a lactic acid bacteria. More preferably, the protease is a metalloprotease and the microorganism is a lactic acid bacteria.

In other preferred embodiments, the microorganism is one or more of Streptococcus, Lactococcus. Lactobacillus. Leuconostoc, Pseudoleuconostoc. Pediococcus, Propionibacterium, Enterococcus, Brevibacterium, or Bifidobacterium or any combination thereof.

In preferred aspects of the present invention, the fermented plant-based product is a high protein yogurt, Greek yogurt, Labneh or sour cream.

In another aspect of the present invention, use of a protease in the production of a fermented high protein plant-based product is presented for:

(a) improving viscosity; (b) improving gel strength; (c) improving texture; (d) improving firmness of curd; (e) providing earlier onset of fermentation; (f) providing earlier onset of gelation; (g) providing earlier conclusion of fermentation; (h) reducing syneresis; (i) improving shelf life; (j) reducing post acidification; (k) improving flavour; (1) reducing stickiness; or (in) any combination of (a) to (1).

In another aspect of the present invention, a method, fermented plant-based product or use as substantially hereinbefore described with reference to any one of the Examples is presented.

In another aspect of the present invention, a method is presented of stabilizing a plant-based milk for use in an acid food matrix comprising treating said plant-based milk with a protease. Preferably, the plant-based milk is soy milk, almond milk, cashew milk, rice milk, coconut milk, macadamia milk or oat milk. Preferably, the acid food matrix is coffee.

Preferably, the protease belongs to Enzyme Commission (E.C.) 3.4.24.x (wherein x is any number). More preferably, the protease is from family M4. Still more preferably, the protease is a metalloprotease or a neutral protease. Yet more preferably, the protease has at least 80, 81, 82, 83, 84, 85, 86, 87, 88, 89, 90, 91, 92, 93, 94, 95, 96, 97, 98, 99 or 100% sequence identity to SEQ ID NO:1. In yet more preferred embodiments, the protease has at least 90% sequence identity to SEQ ID NO:1. Most preferably, the protease has at least 95% sequence identity to SEQ ID NO:1.

### EXAMPLES

### Example 1: Increase in Viscosity of Soy and Pea Protein Slurries with Neutral Endo-Peptidase

An experiment was set up to investigate how the viscosity of soy and pea protein is altered upon treatment with low concentrations of neutral endo-peptidase.

To make slurries of 8% protein content, 18.7 g Supro 760 IP (Lot #180127109, 85.8% protein content) or 19.3 g Trupro 2000 (Lot #G010058562, 83.0% protein content) was mixed with 1 g of NaCl in a tarred beaker. About 150 g water (MilliQ) and 2 mL 2% sodium azide was added and the pH was adjusted to 6.5 with 2M NaOH or HCl. Finally, the total weight of the slurry was adjusted to 200 g with water.

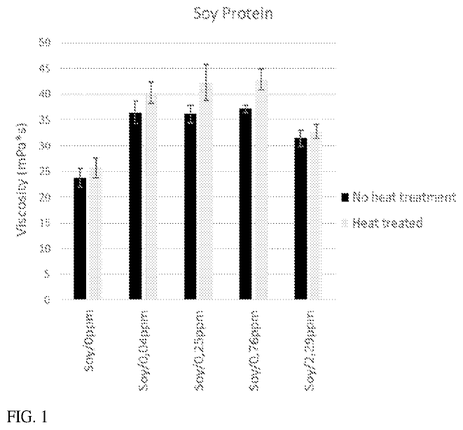

The protein slurries were aliquoted, in portions of 5 g, into 20 mL Wheaton vials. P7L was pre-diluted in 20 mM sodium phosphate buffer. pH 6.5 and added to the protein slurries to obtain the ppm doses (given in ppm relative to either Supro 760 IP or Trupro 2000) indicated in FIGS. 1, 2 and 3. Maximum enzyme addition was 270 μL. Smaller volumes of enzyme addition were compensated by adding buffer up to a total addition of 270 μL. All samples were incubated for 3 hours in a heating block with magnetic stirring at 55° C. and 400 rpm. Temperature was reduced to room temperature by immersing in a water bath for 10 min. Viscosity was measured in triplicate using a Gilson Viscoman Pipette. Bio-Lab, Risskov. Denmark. In some cases, a further heat treatment was given: The samples were brought to 72° C. and kept at this temperature for 30 sec. Subsequently the temperature was brought to room temperature by immersing in a water bath for 10 min where after viscosity was measured again.

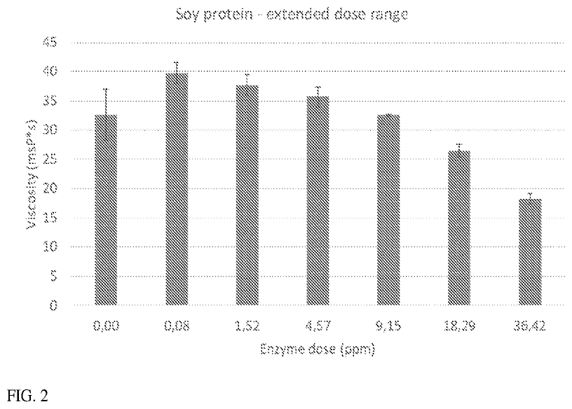

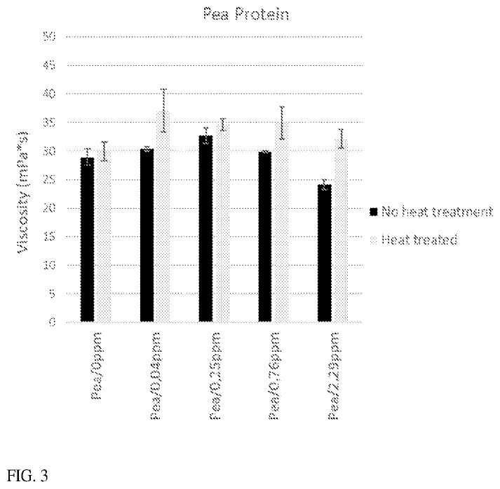

The viscosity measurements of soy protein treated with different doses of enzyme is shown in FIG. 1. It is clear that viscosity increased with doses of P7L up to 0.76 ppm, where after viscosity decreased at a higher dose of P7L. The heat treatment used to generate results in both FIGS. 1 and 3 mimics a mild pasteurization. It is generally seen that this heat enhances the effect on viscosity increase caused by the enzyme. To investigate this phenomenon further the experiment was repeated with an extended dose range of P7L. Again, it was seen (FIG. 2) that viscosity increased at low doses of enzyme here with the peak viscosity obtained at 0.08 ppm P7L. At enzyme doses of 9.15 ppm, viscosity decreases below the no-enzyme reference. A decrease in viscosity by endo-peptidase treatment of a protein is expected due to breakdown of long polymers. FIG. 2 clearly show that a viscosity decrease can also be obtained using this enzyme at dosages above 9.15 ppm. However, the increase in viscosity at low dosages of enzyme is surprising. This effect is likely to be related to the selectivity of the enzyme. The enzyme will hydrolyze peptide bonds preferentially on the N-terminal side of hydrophobic amino acids in the order Leu, Val, Ile, Phe. Therefore, hydrophobic patches from the inner protein are released. The peptides with hydrophobic N-terminals thus generated, are hypothesized to interact by hydrophobic interaction thereby forming a network-like structure in the slurry.

The viscosity measurements of pea protein treated with different doses of P7L is shown in FIG. 3. The results are similar to the results depicted for soy protein in FIG. 1. For pea protein the differences in viscosity caused by the enzyme are much smaller. However, there is a tendency that low doses of enzyme will provide an increase in viscosity. Again, it is generally seen, that the heat treatment enhances the effect on viscosity increase caused by the enzyme.

### Example 2: Thinning and Thickening Effect in Almond Yogurt

P7L was added at the same time as the culture addition during the fermentation process for almond yogurt with 3.6% protein. The base was made with 79% city water, 17% AlmondGOLD ExtraSmooth almond butter 3.5% sucrose, 0.1% calcium citrate and 0.1% tricalcium phosphate. All ingredients were blended under high agitation and allowed to hydrate for 30 minutes. High temperature short time (HTST) pasteurization was completed at 180° F. (82.2° C.) for 7 minutes, and fermentation was performed with 20 DCU/100L Danisco®, VEGE 065 at 110° F. (43.3° C.) until a target pH of 4.65. The time until the target pH was recorded. Five different dosages of the enzyme were tested during fermentation: 2, 4.5, 7, 14, and 18 ppm on protein basis. There was one additional yogurt sample made without enzyme added. After fermentation, all samples were sheared through a homogenizer with 80-100 psi and then stored at 40° F. (4.4° C.) over 67 days shelf life.

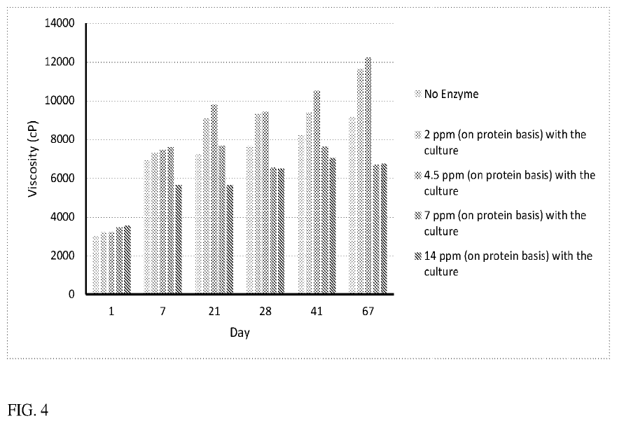

The viscosity of each yogurt was determined using a programmable Brookfield DV3T RV Viscometer (Brookfield Engineering Laboratories, Middleboro, MA, USA) equipped with spindle 6. Samples were measured at 40° F. (4.4° C.), a rotor speed of 20 rpm using a 30 second reading. Viscosity results are shown in FIG. 4

Furthermore, a descriptive sensory with 6 panelists (age: 23-45 years) was performed at day 21 and 67. All panelists were untrained, which ensured a sensory in accordance with consumers training level. All samples were presented to the panelists in 6 ounce translucent cups. The panelists were asked to describe their impression regarding taste and mouthfeel in words.

It was surprisingly found that the P7L dosages of 2-4.5 ppm would result in viscosity increase over the full duration of the trial (67 days) when compared to the sample without P7L addition. Furthermore, a dosage of 7 ppm would also provide an increase in viscosity up until day 28 where after a thinning effect was observed when compared to the sample without enzyme addition. With dosages above 7 ppm only a viscosity increase could be seen at day 1 and at all other timepoints tested, the enzyme resulted in a thinning effect presented here as reduced viscosity compared to the sample without enzyme addition.

The sensory evaluation confirmed the quantified thickening and thinning effect of the various P7L dosages and all was described as “clean and creamy with no off notes or bitterness” at day 21 and 67. For dosages at 7 ppm or above it was even described as cleaner than the control without enzyme.

It was additional found that the fermentation time to reach a pH of 4.65 would decrease with the increasing enzyme dosage (see table 1).

TABLE 1
Time to reach pH of 4.65

| | Ferm Time |
|---|---|
| Treatment | (hour:minutes) |
| No Enzyme | 10:39 |
| P7L at 2 ppm based on protein | 10:29 |
| P7L at 4.5 ppm based on protein | 8:21 |
| P7L at 7 ppm based on protein | 8:10 |
| P7L at 14 ppm based on protein | 7:36 |
| P7L at 18 ppm based on protein | 7:24 |

### Example 3: P7L Replacing Pectin in Almond Yogurt for Thickening Effect with HTST Pasteurization

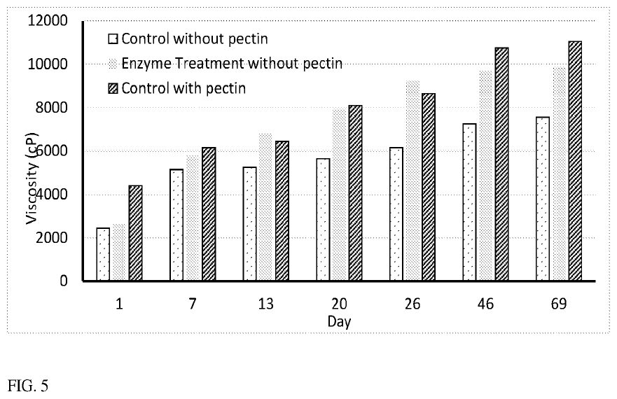

P7L was added at 2 ppm on protein basis at the same time as the culture during the fermentation process. The base fermented consisted of with 3.6% protein. The base was made with 79% city water, 17% AlmondGOLD ExtraSmooth almond butter, 3.5% sucrose, 0.1% calcium citrate and 0.1% tricalcium phosphate. All ingredients were blended under high agitation and allowed to hydrate for 30 min. Two additional almond yogurt samples were prepared without enzyme treatment and with and without pectin (0.10% low methoxyl pectin+0.05% high methoxyl pectin) included. HTST pasteurization was completed at 180° F. (82.2° C.) for 7 minutes, and fermentation was performed with 20 DCU/100L Danisco® VEGE 065 at 110° F. (43.3° C.) until reaching pH 4.65. After fermentation, all samples were sheared through a cooling press with approximately 50 psi and then stored at 40° F. (4.4° C.) over 69 days shelf life. Viscosities were measured over shelf life. Viscosities were determined using a programmable Brookfield DV3T RV Viscometer (Brookfield Engineering Laboratories, Middleboro, MA, USA) equipped with spindle 6. Samples were measured at 40° F. (4.4° C.), a rotor speed of 20 rpm using a 60 second reading. Results are shown in FIG. 5 and display the increase of viscosity over the whole duration of the trial when compared to the reference without enzyme or pectin. The results surprisingly also showed that this increase in viscosity was generally on par with the sample containing pectin.

Furthermore, a descriptive sensory with 4 panelists (age: 23-45 years) was performed at day 69. All panelists were untrained, which ensured a sensory in accordance with consumers training level. All samples were presented to the panelists in 6 ounce translucent cus. The panelists were asked to describe their impression regarding taste and mouthfeel in words and their comments are shown in table 2. No negative effects on flavor was identified when adding P7L.

TABLE 2
Sensory comments

| Sample | Taste description | Mouthfeel description |
|---|---|---|
| Control | Clean and creamy, no off | Smooth mouthfeel |
| without | notes | |
| pectin | | |
| Enzyme | Clean and creamy, no off | Improved thicker mouthfeel |
| Treatment | notes or bitterness, slightly | compared to the control |
| without | extra sweetness compared to | without pectin. Similar |
| pectin | the two controls, helps to | mouthfeel to the control |
| | balance nutty flavors | with pectin. |
| Control with | Clean and creamy, no off | Improved thicker mouthfeel |
| pectin | notes | compared to the control |
| | | without pectin |

### Example 4: P7L Replacing Pectin in Almond Yogurt for Thickening Effect with VAT Pasteurization

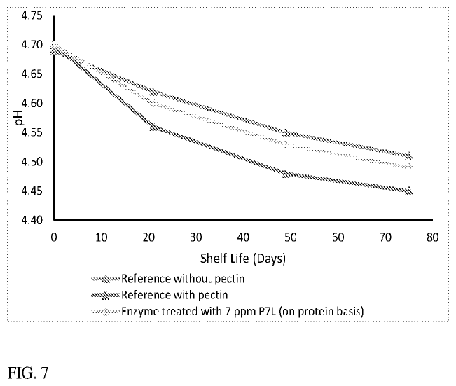

P7L was added at 7 ppm on protein basis at the same time as the culture addition during the fermentation process for almond yogurt with 3.6% protein. The base was made with 79% city water, 17% AlmondGOLD ExtraSmooth almond butter, 3.5% sucrose, 0.1% calcium citrate and 0.1% tricalcium phosphate. Two additional almond yogurt samples were made without enzyme treatment and with and without pectin (0.10% low methoxyl pectin+0.05% high methoxyl pectin) included. VAT pasteurization was completed at 185° F. (85.0° C.) for 30 minutes, and fermentation was performed with 20 DCU/100L Danisco® VEGE 065 at 110° F. (43.3° C.) until reaching pH 4.65. After fermentation, all samples were sheared through a homogenizer with 80-100 psi, and then stored at 40° F. (4.4° C.) over 75 days of shelf life. Viscosities and pH were measured over shelf life. Viscosities were determined using a programmable Brookfield DV3T RV Viscometer (Brookfield Engineering Laboratories, Middleboro, MA, USA) equipped with spindle 6. Samples were measured at 40° F. (4.4° C.), a rotor speed of 20 rpm using a 30 second reading. The pH of the yogurts was also measured over shelf life to evaluate post fermentation acidification of the samples (see FIG. 7).

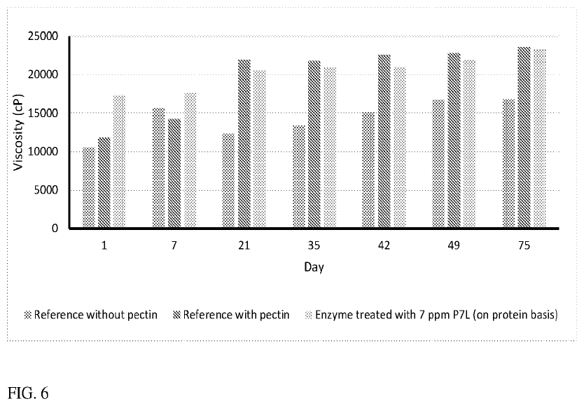

The viscosity of the yogurts over shelf life are shown in FIG. 6. In contrast to experiment 2 (using HTST pasteurization) where a dosage of 7 ppm would cause a thinning effect at shelf life above 21 days it was surprisingly found that the increase in viscosity compared to the reference sample was maintained over the whole shelf life. It was therefore clear that the effect of the enzyme could be modulated by changing the pasteurization parameters. The increase in viscosity was generally on par with the sample containing pectin over the shelf life of the yogurts.

It was furthermore found that the samples with P7L addition would have less post acidification compared to the sample with pectin and instead the post acidification trend of the enzyme added sample would be more comparable to the reference sample.

### Example 5: Thinning and Thickening Effect in Coconut and Pea Yogurt with VAT Pasteurization

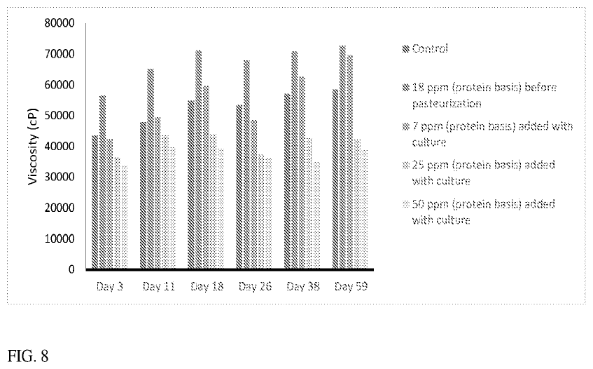

P7L was added at 7, 25, or 50 ppm on protein basis at the same time as the culture during the fermentation process for coconut and pea protein yogurt. The base was made with 86% city water, 7.9% TRUPRO 2000 Pea Protein concentrate (approximately 6.6% total protein), 3% sucrose, and 3% Columbus Vegetable Oils 76° coconut oil. All ingredients were blended under high agitation and allowed to hydrate for 30 min. As a control, one sample without any enzyme treatment was prepared. Furthermore, one sample was treated with 18 ppm P7L on protein basis for 1.25 hours under refrigeration conditions prior to the pasteurization step and no further enzyme was added during fermentation. VAT pasteurization was completed at 190° F. (87.8° C.) for 30 minutes, and fermentation was performed with 20 DCU/100L Danisco® VEGE 022 at 110° F. (43.3° C.) until reaching pH 4.65. After fermentation, samples were cooled to 70-80° F. (21.1-26.7° C.) and sheared through a homogenizer with 80-100 psi, and then stored at 40° F. (4.4° C.) over 59 days shelf life. Viscosities were determined using a programmable Brookfield DV3T RV Viscometer (Brookfield Engineering Laboratories, Middleboro, MA. USA) equipped with spindle 6. Samples were measured at 40° F. (4.4° C.), a rotor speed of 10 rpm using a 30 second reading. Results of the viscosity measurement is shown in FIG. 8. It was found that viscosity was increased compared to control if using a dosage of 7 ppm enzyme (on protein basis) added together with culture or if preincubating at a dosage of 18 ppm (on protein basis) for 1.25 hours under refrigeration conditions prior to the pasteurization step. The dosages of 25 and 50 ppm resulted in a thinning effect.

Furthermore, a descriptive sensory with 4 panelists (age: 23-45 years) was performed at day 59. All panelists were untrained, which ensured a sensory in accordance with consumers training level. All samples were presented to the panelists in 6 ounce translucent cups. The panelists were asked to describe their impression regarding taste and mouthfeel in words. The control sample was described as smooth with earthy off notes and bitterness from pea protein. For the enzyme added samples the measured increase or decrease of texture was confined and flavor was described as cleaner taste compared to the control with less earthy and beany notes.

### Example 6: Thinning Effect in Fermented Pea Protein Model Beverage

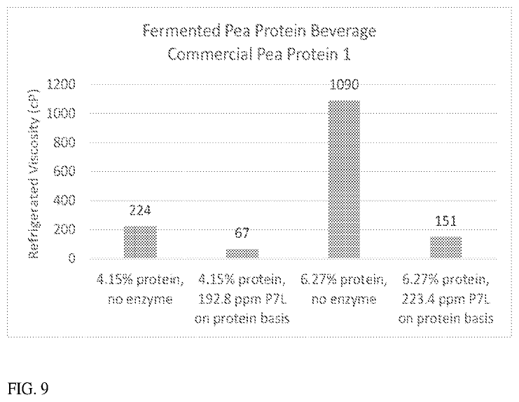

Fermented pea protein beverages was made with either 4.15% or 6.27% protein and 4.0% sucrose, 1.8% sunflower oil, 0.10% deoiled sunflower lecithin, and 0.04% gellan gum. The base was high temperature short time (HTST) vat pasteurized at 185-190F for 6-7 minutes, and fermentation was performed with 20 DCU/100L Danisco® VEGE 047 at IOF (43.3C) until reaching pH 4.6. P7L was added together with culture addition during the fermentation process. The sample containing 4.15% pea protein was dosed 192.8 ppm enzyme on protein basis and the sample containing 6.27% pea protein was dosed 223.3 ppm enzyme on a protein basis. Control samples with no enzyme were also prepared as references at the same protein levels. After fermentation, all samples were stirred using a high shear mixer and then stored at 40F (4.4C). Viscosities were measured after 24-hours using a Brookfield RV Viscometer with spindle 2 or 4.60 rpm, 1-minute reading at 40-45F. The viscosity of the samples is shown in FIG. 9, and clearly show how the enzyme dosages cause a thinning effect of the yogurts compared to the reference samples without enzyme.

### Example 7: Thickening and Thinning in Soy Protein Fermented Beverages

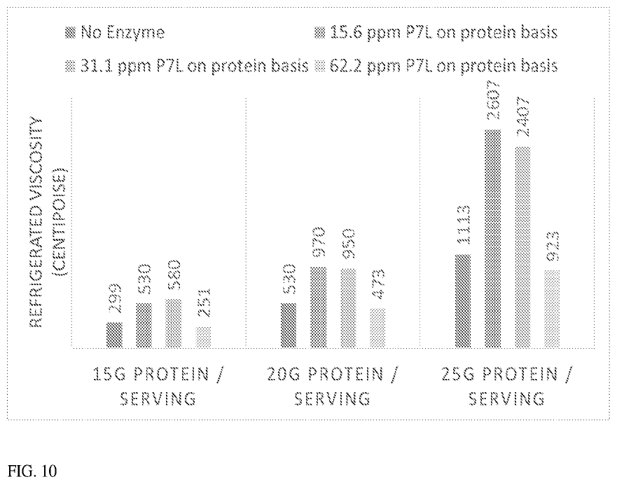

P7L was added at the same time as the culture during the fermentation process to prepare a fermented soy protein beverage with 15, 20, or 25-g protein per 296 mL serving and 3.5% sucrose, 1.8% sunflower oil, 0.10% deoiled sunflower lecithin, 0.03% stevia, 0.50% mango flavor, and 0.04% gellan gum. Hence, the samples contained 5.067, 6.750 and 7.802% soy protein from SUPROV XT 219. The base was pasteurized high temperature short time (HTST) vat at 180-190F for 6-7 minutes, and fermentation was performed with 20 DCU/100L Danisco® VEGE 047 at 1° F. (43.3C) until reaching pH 4.5-5.0. A control samples as well as samples dosed 15.6, 31.1 or 62.2 ppm enzyme on a protein basis was prepared for each soy protein level. After fermentation, all samples were smoothened using a high shear mixer (Thermomix) and then stored at 40F (4.4C). Viscosities were measured after 24-hours using a Brookfield RV Viscometer, 60 rpm, 30-second reading at 40-45F using Spindle 3, 4, or 5 depending on sample thickness (see FIG. 10). The data clearly show both a thickening and thinning options depending on the P7L dosage.

### Example 8: Improved Stability of Enzymatically Treated Plant-Materials in Acid Food Matrices

To prepare the initial oat base, 320 kg tab water were heated to 65° C. and mixed with the amylase-preparations FoodPro ALT (0.16 kg) and FoodPro CGL (1.6 kg). Subsequently, oat flour (80 kg) was added. The oat flour (whole grain oat fine powder 2000, 2000 FP 200) was purchased from Fazer Mills (Lahti, Finland) and included 7.2% fat, 56% carbohydrates, 10% dietary fibers, 13.5% protein and 0.003% salt. The mixture was incubated for 90 min at 65° C. under continuous stirring. After this incubation, the mixture was heated to 95° C. for 10 min to inactivate the enzyme and subsequently cooled to 70° C. When the temperature of 70° C. was reached, the slurry was pumped to a decanter. The decanter was set at 6700 rpm and a delta n of 15.3 rpm. The so produced oat-base was UHT-treated at 143° C. for 4 s and cooled and stored at −18° C. until further use. To produce the oat barista beverage (oat drink), 6 kg of the oat base was mixed with 5.66 kg water at 55° C. For the enzymatic treatment, either 0.1 ppm, 0.5 ppm or 1 ppm P7L was added to the mix and incubated for further 60 min under continuous stirring. A control without enzyme was prepared in the same manner, but without P7L-addition. After the incubation, 12 g SOLAC SF-D, 3.6 g Gellan VEG 2000 and 8.58 g sodium chloride were added to all samples. The control additionally included 0.1% (w/w) sodium tri-polyphosphate. To the so prepared samples, 300 g sunflower oil was added and mixed at 4000 rpm for further 2 min. All samples were subsequently UHT-treated at 140C for 5 s and homogenized at 75° C. and 40 bar. Samples were filled in 250 mL bottles, cooled to 10° C. and stored at 5° C. until further use.

For analyzing the behavior of the oat beverages an Oracle BES980 barista machine (Sage. London, UK) was used. The espresso (100 g, grind 37 coffee beans) was produced under the conditions recommended by the supplier's handbook Steam frothing was performed at standard settings of the barista machine. The automatic frothing was set to maximum texture and stopped the steam frothing temperature of 67° C.

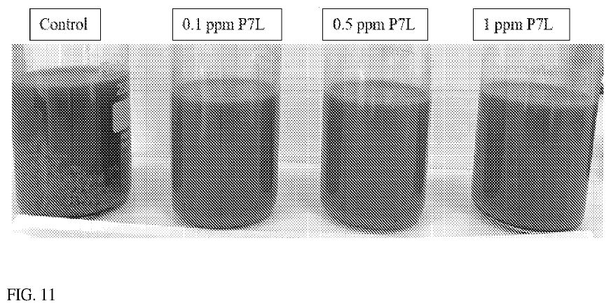

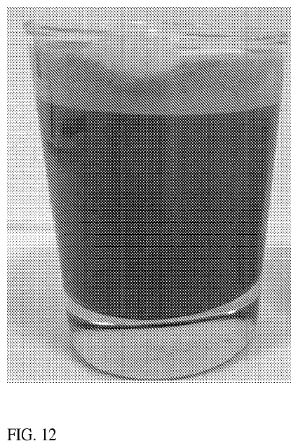

The reference oat beverage (without the enzymatic-treatment) showed curdling 20 s after mixing 50 g of the oat beverage into 100 g espresso with a pH of 5. When using the oat beverage treated with P7 in the same coffee drink no curdling occurred while purring the drink into the coffee (see FIG. 12). Curdling was visible 240 (0.1 ppm P7L), 90 (0.5 ppm P7L) and 300 s (1 ppm P7L) after mixing the oat drink and the coffee. Furthermore, the curdled particles were small and still well dispersed in the drink for the P7L-treated oat-drink (see FIG. 11). In contrast, the control without P7L resulted in large humps which precipitated at the bottom of the coffee-drink. All oat-milks treated with P7L showed steam frothing properties in a barista machine and resulted in a head of foam in the final coffee-drink (see exemplary FIG. 12).

Furthermore, a descriptive sensory with 4 panelists (age: 30-53 years) was performed. All panelists were untrained, which ensured a sensory in accordance with consumers training level. All samples were presented to the panelists one week after production in 6 ounce translucent cups. The panelists were asked to describe their impression regarding taste and mouthfeel in words. In a direct comparison, all oat-drinks prepared with P7L were described to have a milder oat taste and more creamy mouthfeel compared to the non-enzyme treated control.

1. A method for preparing a fermented plant-based product, the method comprising:
(a) treating a plant-based liquid substrate comprising a plant protein content of 1, 2, 3, 4, 5, 6, 7, 8, 9 or 10% (w/w) or higher with a protease and a microorganism; and
(b) allowing the treated substrate to ferment to produce the fermented plant-based product.

2. The method of claim 1 wherein the plant protein content is 6% (w/w) or higher.

3. The method of claims 1 or 2 wherein the plant protein is derived from soy, almond, pea, bean, rice or oat.

4. The method of any one of the preceding claims, wherein said protease belongs to Enzyme Conmission (E.C.) 3.4.24.x (wherein x is any number).

5. The method of any one of the preceding claims, wherein said protease is from family M4.

6. The method of any one of the preceding claims, wherein said protease is a metalloprotease.

7. The method of claim 6, wherein said protease has at least 80, 81, 82, 83, 84, 85, 86, 87, 88, 89, 90, 91, 92, 93, 94, 95, 96, 97, 98, 99 or 100% sequence identity to SEQ ID NO:1.

8. The method of claim 7, wherein said protease has at least 90% sequence identity to SEQ ID NO:1.

9. The method of claim 8, wherein said protease has at least 95% sequence identity to SEQ ID NO:1.

10. The method of any one of the preceding claims, wherein said plant-based liquid substrate is treated with said protease before adding said microorganism.

11. The method of any of claims 1 to 9, wherein said proteases is added together with said microorganism.

12. The method of any claims 1 to 9 wherein said protease is added after addition of said microorganism.

13. The method of any one of claims 10 to 12, wherein said protease is a metalloprotease and wherein said microorganism is a lactic acid bacteria.

14. The method of any one of the preceding claims, wherein the microorganism is a lactic acid bacterium.

15. The method of any of claims 1 to 12, wherein the microorganism comprises one or more of Streptococcus, Lactococcus, Lactobacillus, Leuconostoc, Pseudoleuconostoc, Pediococcus, Propionibacteriun, Enterococcus, Brevibacterium, or Bifidobacterium or any combination thereof.

16. A fermented plant-based product obtainable by the method as claimed in any of the preceding claims.

17. A fermented plant-based product which has a plant protein content of 1, 2, 3, 4, 5, 6, 7, 8, 9 or 10% (w/w) or higher and which comprises one or more exogenous proteases and an exogenous microorganism.

18. The fermented plant-based product of claim 17, wherein the plant protein content is 6% (w/w) or higher.

19. The fermented plant-based product of claims 17 or 18 wherein the plant protein is derived from soy, almond, pea, bean, rice or oat.

20. The fermented plant-based product of any of claims 17 to 19, wherein one of said one or more proteases belongs to Enzyme Commission (E.C.) No. 3.4.24.x (wherein x is any number).

21. The fermented plant-based product of claim 20, wherein said one protease belonging to Enzyme Commission (E.C.) No. 3.4.24.x (wherein x is any number) is from family M4.

22. The fermented plant-based product of any of claims 17 to 21, wherein one of said one or more proteases is a metalloprotease.

23. The fermented plant-based product of claim 22 wherein said metalloprotease has at least 80, 81, 82, 83, 84, 85, 86, 87, 88, 89, 90, 91, 92, 93, 94, 95, 96, 97, 98 or 99% identity with the amino acid sequence of SEQ ID NO:1.

24. The fermented plant-based product of claim 23, wherein said protease has at least 90% sequencer identity to SEQ ID NO:1.

25. The fermented plant-based product of claim 24, wherein said protease has at least 95% sequence identity to SEQ ID NO:1.

26. The fermented plant-based product of any of claims 17 to 20, wherein one of said one or more proteases is a neutral protease.

27. The fermented plant-based product of any of claims 17 to 26, wherein the microorganism is a lactic acid bacterium.

28. The fermented plant-based product of any of claims 17 to 27, wherein the microorganism comprises one or more of Streptococcus, Lactococcus, Lactobacillus, Leuconostoc, Pseudoleuconostoc, Pediococcus, Propionibacterium, Enterococcus, Brevibadeum or Bifidobacterium or any combination thereof.

29. A fermented plant-based product according to any one of claims 17 to 28, wherein the fermented plant-based product is a high protein yogurt, Greek yogurt, Labneh or sour cream.

30. Use of a protease in the production of a fermented high protein plant-based product for:
(a) improving viscosity;
(b) improving gel strength;
(c) improving texture;
(d) improving firmness of curd;
(e) providing earlier onset of fermentation;
(f) providing earlier onset of gelation;
(g) providing earlier conclusion of fermentation;
(h) reducing syneresis;
(i) improving shelf life;
(j) reducing post acidification
(k) improving flavor;
(l) reducing stickiness; or
(m) any combination of (a) to (l).

31. A method, fermented plant-based product or use as substantially hereinbefore described with reference to any one of the Examples.

32. A method of stabilizing a plant-based milk for use in an acid food matrix comprising treating said plant-based milk with a protease.

33. The method of claim 32 wherein the plant-based milk is soy milk, almond milk, cashew milk, rice milk, coconut milk, macadamia milk or oat milk.

34. The method of claims 32 or 33 wherein the acid food matrix is coffee.

35. The method of any of claims 32 to 34 wherein said protease belongs to Enzyme Commission (E.C.) No. 3.4.24.x (wherein x is any number).

36. The method of claim 35, wherein said protease is from family M4.

37. The method of claim 36, wherein said protease is a metalloprotease.

38. The method of claim 37, wherein said protease has at least 80, 81, 82, 83, 84, 85, 86, 87, 88, 89, 90, 91, 92, 93, 94, 95, 96, 97, 98, 99 or 100% sequence identity to SEQ ID NO:1.

39. The method of claim 38, wherein said protease has at least 90% sequence identity to SEQ ID NO:1.

40. The method of claim 39, wherein said protease has at least 95% sequence identity to SEQ ID NO:1.
